(19) United States
(12) Patent Application Publication
(10) Pub. No.: US 2007/0142935 A1
(43) Pub. Date: Jun. 21, 2007

(54) Method and arrangement in a computer system for controlling a process

(76) Inventors: Bjorn Martin Danielsson, Sollentuna (SE); Jan-Erik Gustavsson, Taby (SE)

Correspondence Address: COATS & BENNETT, PLLC, 1400 Crescent Green, Suite 300, Cary, NC, 27518, US

(21) Appl. No.: 11/312,765

(22) Filed: Dec. 20, 2005

(51) Int. Cl. G05B 13/02

(52) U.S. Cl. 700/29

(57) ABSTRACT

The present invention relates to methods and arrangements in a computer system for controlling processes. A process is described as a number of process variables and as process elements, each process element including a rule for transitions to at least one other process element and actions to be performed when the process element is active. An active process state is described as a number of process elements including their actions, and as current values of the process variables. By making transition calculations to a new process state in two separate steps by first calculating new process variable values based on current process variable values and on actions in the current active process elements and then calculating new active process elements based on the new process variables and on the rules in the current active process elements, a process control system and method is received that is flexible enough to handle most different kinds of processes and that can be realised with a limited amount of program code.

### FIELD OF THE INVENTION

The present invention relates to methods and arrangements in a computer system for controlling processes, wherein the process may be any kind of process such as an administrative or industrial process.

### BACKGROUND OF THE INVENTION

A process, generally speaking, is anything that has an abstract state that evolves by changing between different concrete process states. The phrase “abstract state” here simply means that the set of concrete states can be represented as a common permanent structure with a set of varying parameters. A process may for example be any kind of administrative or industrial process. An example of an administrative process may be the handling of clinical trials of new pharmaceutical drugs, wherein a clinical trial can proceed between different states in the process from when the drug has left the laboratory until the drug has been approved by a regulatory body of a country, e.g. by the Food and Drug Administration, FDA, in the US. Such a process could be modeled as different states, and for the process to proceed to a new state, certain conditions have to be fulfilled. This process is rather complicated in the way that more than one subprocess could be ongoing simultaneously.

Processes are historically modeled by using a Finite state machine model. A Finite state machine is represented by a graph where each vertex in the graph represents a distinct process state. The vertices are connected by directed arcs that represent state transitions. Each such arc is associated with a condition for transition between the process states connected by the arcs. When all outgoing arcs from a given vertex have mutually exclusive conditions, the finite state machine is said to be deterministic.

A Moore machine is a finite state machine that associates an output-producing action with each state. This makes the finite state machine model useful for modelling of realistic processes. Many physical processes, performed by electronic hardware, e.g. by simple digital circuits such as shift registers, can be modeled in a straight-forward way by Moore machines. A Moore machine is described in “Gedanken-experiments on sequential machines”, by E. Moore, in Automata Studies, Annals of Mathematical Studies, no. 34, published by Princeton University Press in 1956. FIG. 1 describes a Moore machine model of a process for detecting the bit sequence “11”. The model contains three distinct states which the process may take, represented by vertices S1, S2, S3. The process starts in vertex S1, i.e. the first process state would be S1. Two arcs originate from S1. The process will proceed to state S2 if a bit “1” is detected, i.e. the condition for transiting from process state S1 to S2 would be “1”. If a “0” is detected, the process will stay in state S1. When in state S2, the process will transit to state S3 if another “1” is detected. In that case, when reaching process state S3, the process will perform the action of printing “yes”. On the other hand, if a “0” would be detected when in S2, the next process state will be S1 again.

A Mealy machine is an alternative to the Moore machine. A Mealy machine associates an output producing action with each arc in the graph. Mealy machines can always be modeled by Moore machines that have extra intermediate states. The Mealy machine is described in “A method for synthesizing sequential circuits” by G. H. Mealy published in Bell System Tech. J. vol 34, in 1955.

Prior art systems for controlling processes often rely on the models described above. These models cannot be used for complex processes, for example where a process state cannot be represented by a single graph vertex. There also exist methods and arrangements in computer systems for controlling processes, which methods and arrangements are especially designed for certain processes. Often, computer program code used in such methods and arrangements tends to become very long and complex. Also, such code is often tedious to rewrite if any new states need to be included in the process. Also, such arrangements cannot easily be used for other processes than the process it is designed for. Therefore, the invention aims at presenting a method and an arrangement in a computer system for controlling any type of process, which method and arrangement can handle changes in an existing process flexibly.

### SUMMARY OF THE INVENTION

The present invention can be used to control any kind of process, including complex processes, and to flexibly handle changes in the process. This is achieved by describing the process as a set of process elements, each process element being associated with at least an action and a rule, which rule defines transitions to other process elements, and as values of a number of process variables. A process is momentarily described as an active process state, the state being represented by a number of active process elements and by current values of the number of process variables. When the process evolves from a first process state being active to a second process state being active, a two-part procedure is followed. First, new values of the state variables are calculated based on the current values of the process variables and on the actions of the current active process elements. Then, new active process elements are calculated based on the rules of the current active process elements and the calculated new values of the state variables.

By separating the calculation for the new active process state into two steps, the process could be efficiently described with computer program code, such that the amount of code to be used for describing the process and process transitions can be kept on a low level.

According to an embodiment of the invention, the rules are described using first-order predicate logic. This facilitates the description of a process, and process transitions with computer program code.

An advantage of the present invention relies in the fact that changes in the process can be handled easily.

A further advantage of the present invention is that, compared to prior art methods and arrangements for controlling processes, a small amount of computer program code has to be used, resulting in a compact program code. Since the program code can be made compact, calculations can be executed fast. Also, a rather simple, and, consequently, a cheap computer or computer system can be used on which the program code is implemented.

By separating the rule based logic from the process logic, i.e. from the actual process state transition control, a transaction security is achieved. This is achieved because evaluation of the rules becomes idempotent when using predicate logic. Thereby, it is guaranteed that even if a calculation of new process state has to be recalculated due to e.g. server breakdown, a new rule evaluation will not be influenced by any earlier evaluation of the rule. I.e. a transaction from a first process state, when the process data is the same, will always end up in the same new process state.

Another advantage of the invention relies in the fact that the logic that is used to control transitions can be verified, analyzed and optimized through the use of formal mathematical proof methods.

### BRIEF DESCRIPTION OF THE DRAWINGS

The invention will in the following be described in more detail with reference to enclosed drawings, wherein:

FIG. 1 describes a state diagram based on a Moore machine model for an exemplary process;

FIG. 2 shows a state diagram for an exemplary process based on a first embodiment of the invention;

FIG. 3 shows a state diagram for another exemplary process based on a second embodiment of the invention;

FIG. 4 describes a schematic block diagram of an arrangement for controlling a process according to an embodiment of the invention;

FIG. 5 shows a flow chart according to an embodiment of the invention;

FIG. 6 shows a flow chart according to another embodiment of the invention;

FIG. 7 illustrates a flow chart according to yet another embodiment of the invention;

FIG. 8 illustrates a flow chart according to yet another embodiment of the invention;

FIG. 9 illustrates a schematic block diagram of another arrangement for controlling a process; and

FIG. 10 shows a schematic block diagram of a rule handling unit and its communication with a process handling unit.

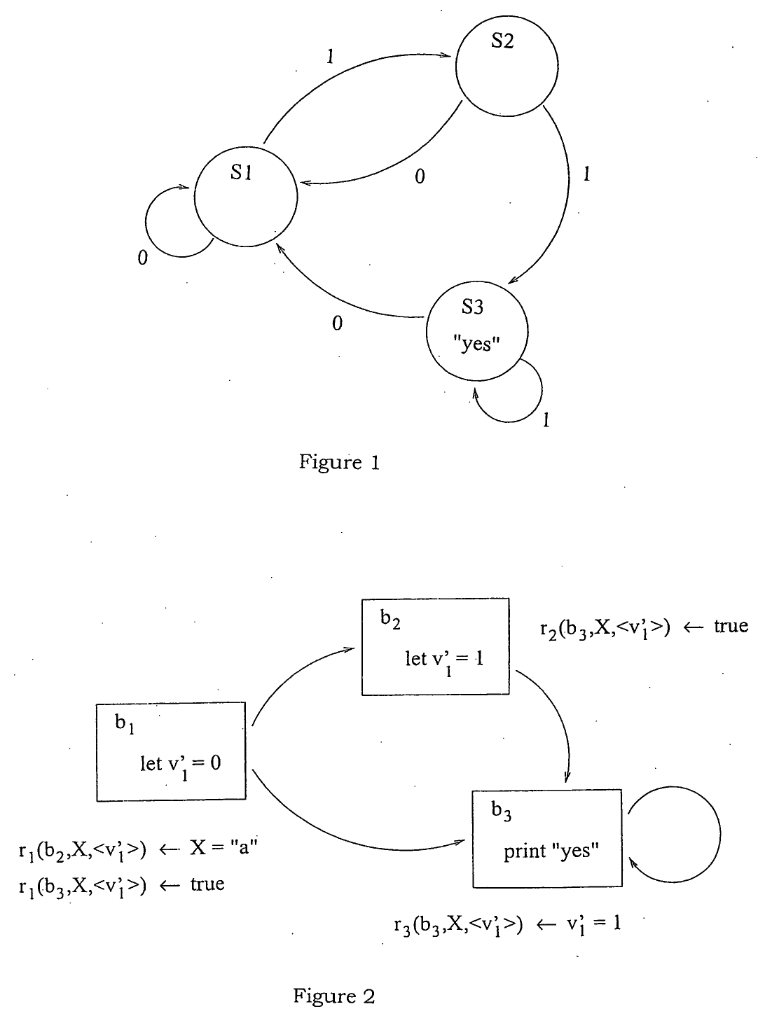

### DETAILED DESCRIPTION

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

A process state is defined as the state in which a process could be described at a certain moment. As the process changes, it moves between different process states until the process stops. The process state that the process is currently in is called an active process state. In the prior art Moore machine model, a graph vertex represents a distinct process state. By this prior art model, not all kinds of processes can be described.

To be able to model all kinds of processes, the process model used in the invention extends the prior art Moore Machine model in two ways:
By removing the restriction that a state is represented by a single graph vertex. Instead, the process state is extended to be represented by a set of vertices (or rather a multiset of vertices).
By adding process state variables to the process state. Such state variables add representational power to the model. For example, the “tape” of a Turing Machine, which is another type of process model, is naturally modeled by a state variable, while the states of the Turing Machine may be mapped directly to graph vertices.

In the process model of the invention, a graph vertex is called a process element, and a process state is described as a number of process elements and as values of the number of state variables. The active process state is described as the process elements in the active process state and the current values of the state variables. Each process element is associated with an action and a rule. The rule defines transitions from the process element to other process elements. The action describes what operation to perform when the process element is in the active process state. The action may be omitted, i.e. the action may be to do nothing with the process, in which case the only state change involved is the transition to this process element. If a process could be realised as a Moore machine, each process state in such a process would only be described as one process element.

The rule or rules associated with each process element selects which process element(s) to go to in the next process state transition. Compared to the process graph, the rule or rules of a graph vertex, i.e. a process element, is applied to each of the outgoing arcs from the graph vertex. Each time the rule allows it, the graph vertex, i.e. process element, that the arc points to is selected for the next state transition. The rule may only be to define to which process element to proceed. In that case an arc in the process graph constitute an allowed transition, without any condition associated with the transition. If a process element is in the active process state, the rule(s) of that process element is checked in the next state transition.

In the method for controlling a process according to the invention, the method controls transitions from one active process state, called a first process state to a new active process state, called a second process state, by decomposing a transition function into two parts: A first part that changes the process state variables and a second part that uses pure logic to determine the next transitions to the process elements to be incorporated in the new active state. The first part is carried out by calculating values in the second process state for the number of state variables as a function of values in the first process state for the number of state variables and of actions associated with the number of process elements in the first process state. The second part is carried out by calculating process elements in the second process state as a function of the rules associated with the number of process elements in the first process state and the calculated values in the second process state for the number of state variables. The new active process state, i.e. the second process state is then described by the values of the variables in the second process state and the process elements in the second process state. If the model of the process is described for a user e.g. via a graphical user interface, the new active process state, i.e. the second process state, will be presented at the GUI.

In the following, a method for controlling a synchronous process according to a first embodiment of the invention is described. The process is modeled by a set of process elements bᵢ and a set of state variables vᵢ. Each process element has at least one action and a rule associated with it. Each rule defines transitions to other process elements. The active process state consists of a multiset of currently active process elements A together with the current values of the state variables. (A multiset is an unordered collection of objects where multiple occurrences of the same object is significant.) The transition from a first process state to a second process state is determined by A, by the values of the state variables in the first state vᵢ, and possibly also by an ordering of the active process elements for each transition.

Formally, the synchronous process model and transitions in the model could be described as follows:

Let aᵢ denote an enumeration of the process elements bᵢ that are members of A, and which represents a specific order of execution. If the state transition function is called ƒ we can describe deterministic state transitions as:
(a′, v′)=ƒ(X,(a,v))
Where:
a=(a₁, a₂, . . . aₘ) denotes the process elements in the currently active state;
v=(V₁, v₂, . . . vₙ) denotes the values of the state variables in the currently active state;
X=all external inputs that can influence the state transition (may be omitted);
a′=(a′₁, a′₂, . . . , a′ₖ) denotes the process elements in the process state following the currently active state (first process state);
v′=(v′₁, v′₂, . . . , v′ₙ) denotes the values of the state variables in the process state following the currently active state (second process state);
The transition function ƒ is naturally split into two functions:
a′=ƒₐ(X,(a,v))
v′=ƒᵥ(X,(a,v))

But this is not very practical, since it is often desirable to have different mappings a to a′ depending on the updated values of the state variables v′. Therefore, according to the invention, the following decomposition is suggested:
v′=updates (X,(a,v))
a′=activations (X,(a, v′))
i.e. the function that produces a′ operates on v′ not on v.

The function “updates” produces a new set of values of the state variables from the actions of the active process elements A, where the actions are ordered according to the enumeration a.

The function “activations” produces a new multiset A of active process elements, with some unspecified ordering a′.

According to the invention, the process elements in A, which are enumerated by a′, are produced by rules rᵢ associated with the process elements bᵢ. Each such rule is a logic predicate that is applied to the arcs connecting the process elements in a process graph, i.e. the rules define to which process elements the active process elements may transit, and which conditions that have to be fulfilled for such transitions. For each transition (bᵢ, bⱼ), the process element bⱼ is added to A if bᵢ is in A and rᵢ (bⱼ, X, v′) is true. If all predicates are false, A will be empty and the process terminates. This captures a basic idea behind the invention: For controlling transitions in the process from a first process state being active to a second process state being active: decomposing the transition function into one part that changes the state variables, and another part that uses pure logic to select the actions that will determine the next transition, i.e. to determine the process elements or process elements in the second process state. Thereby it is achieved that the logic that is used to control transitions can be verified, analyzed and optimized through the use of formal mathematical proof methods. This is especially useful in the case of transitions that effectuate automated decisions.

FIG. 2 describes an example for controlling a process according to this first embodiment of the invention. FIG. 2 shows a process comprising one state variable v₁ and three boxes b₁, b₂, b₃, each illustrating a process element. Each process element is associated with a rule (r₁, r₂, r₃) and an action, wherein each action is written in the boxes in the figure. The process elements are connected via arcs in a directed graph (or more precisely, a vertex-labelled pseudo-graph). A rule is defined for the arcs originating in one box, such that the left part of the rule formula in FIG. 2 defines to which process element(s) a transition is defined and which values and inputs that are relevant, and the right part of the formula defines which condition that has to be fulfilled for the transition. “True” means that there is no condition for the transition. The state of the process in FIG. 2 evolves in the way described in the table below, assuming that for the initial state A=(b₁). v₁ has no value, and the initial external input X is “a”.

| A | v₁ | output |
|---|---|---|
| (b₁) | | |
| (b₂, b₃) | 0 | |
| (b₃, b₃) | 1 | yes |
| (b₃, b₃) | 1 | yes yes |
| (b₃, b₃) | 1 | yes yes |
| Etc . . . | | |

If the initial external input had been “b” instead, the progression of states would be (b1) followed by (b3), after which the process would have terminated since v1≠1.

The solution described above assumes that all actions are synchronous, i.e. the actions of aᵢ are all performed before any of the rules rᵢ are applied. In the following a method for controlling an asynchronous process according to a second embodiment of the invention is described. In this case, a process element that has completed its action can activate its successor process elements immediately, without having to wait for the completion of concurrent actions. The second embodiment accommodates this by decomposing the transition function further.

In the second embodiment, each process element bᵢ has its own pair of “updates” and “activations” functions:
δ=updatesᵢ (X, v)
α=activations (X, v)={:(bᵢ, β) belongs to Θ and rᵢ(β, X, v)}
   where δ denotes a set of updates to the state variables, a denotes the process elements activated by process element bᵢ, Θ is the set of arcs (bᵢ, bⱼ) in the process description graph, and rᵢ is the rule for transition from process element bᵢ. The functions “updatesᵢ” and “activationsᵢ” are used in the following way to produce the state transitions. The multiset A is split into two separate multisets A_{action} and A_{cont}. The following steps are performed repeatedly, in an unspecified order:
Remove an element bᵢ from A_{action} and apply the function “updatesᵢ” to obtain δ. The current values of X and v are used. Update the state variables with the changes in δ. Insert bᵢ into A_{cont}.
Remove an element bᵢ from A_{cont} and apply the function “activationsᵢ” to obtain α. Add each element of a to A_{action}.

This procedure causes each process element that enters A_{action} to move to A_{cont} and then to be removed. But since the process elements are moved in an unspecified order, the procedure introduces indeterminacy in the progression of process states when more than one process element is present in A. This indeterminacy models the temporal indeterminacy of concurrent processes in the real world. (Even though there is no explicit concept of time in the process model, the sequence of state transitions implicitly defines a temporal order.)

For sequential processes, i.e. those that never have more than one process element in A, the asynchronous model is equivalent to the synchronous model described earlier. For more complex processes with concurrent actions, the asynchronous model of the second embodiment may be necessary. However, the temporal indeterminacy is not an issue when it is just a case of stepwise execution of independent subprocesses, where the situation is provably equivalent to the decomposition in the synchronous case as described above. In the cases where subprocesses are not independent, explicit synchronization of actions is necessary in order to get predictable semantics and avoid race conditions. Synchronization of actions may be performed by using semaphores, which will be described more thoroughly further down in the document.

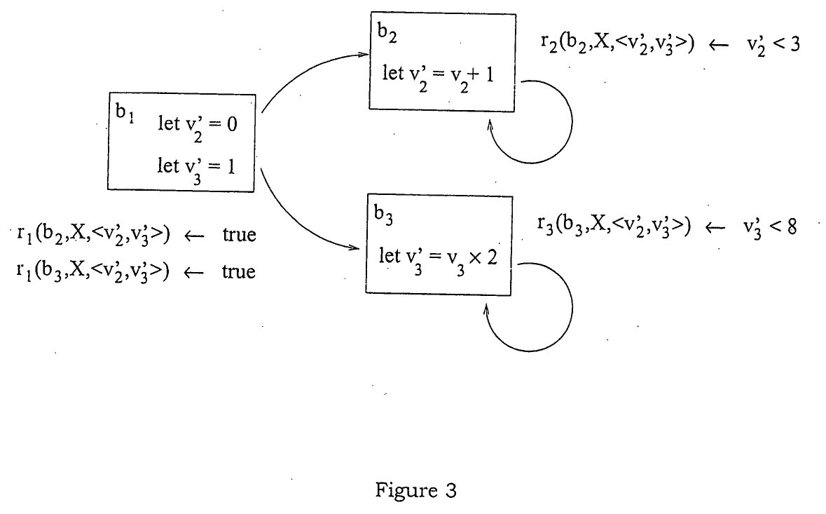

FIG. 3 shows an example of an asynchronous process model controlled according to the second embodiment of the invention. FIG. 3 shows a process comprising two state variables v₂ and v₃, and three boxes b₁, b₂, b₃, each illustrating a process element. Each process element is associated with a rule (r₁, r₂, r₃) and an action, wherein each action is written in the boxes in the figure. The boxes are connected via arcs in a directed graph (or more precisely, a vertex-labelled pseudo-graph). A rule is defined for the arcs originating in one box, such that the left part of the rule formula in FIG. 2 defines to which process element(s) or boxes a transition is defined and which values and inputs that are relevant, and the right part of the formula defines which condition that has to be fulfilled for the transition. The action of box b₂ is an addition operation, whereas the action of box b₃ is a multiplication operation. In the process it is assumed that it takes twice as long time to multiply two numbers than to add two numbers. The state of the process in FIG. 3 evolves in the following way, assuming that the initial state is {b₁}:

| A_{action} | A_{cont} | v₂ | v₃ |
|---|---|---|---|
| {b₁} | { } | | |
| { } | {b₁} | 0 | 1 |
| {b₂, b₃} | { } | 0 | 1 |
| {b₃} | {b₂} | 1 | 1 |
| {b₂} | {b₃} | 1 | 2 |
| {b₃} | {b₂} | 2 | 2 |
| {b₂, b₃} | { } | 2 | 2 |
| { } | {b₂, b₃} | 3 | 4 |
| {b₃} | { } | 3 | 4 |
| { } | {b₃} | 3 | 8 |
| { } | { } | 3 | 8 |

As can be seen in FIG. 3 and from the table above, the b2 iteration loop proceeds without waiting for the action of b₃. If this had been a synchronous process instead, the iterations would have been made simultaneously. Since in this case the b₂ loop and the b₃ loop are independent of each other, the end result would be the same, as well as the progression of each loop considered separately. Although, if the b₂ loop and the b₃ loop would have been dependent of each other, the asynchronous second embodiment would have been necessary to use.

As mentioned above, the rules for deciding which process elements that are to be a part of the next process state are specified using logic, and according to an advantageous embodiment the rules are specified using first-order predicate logic. Predicate logic is about propositions that make claims about all or some, e.g. “some cats are black” or “all Cretans are liars”. Formally, a predicate is a relation between n objects (the predicate arguments), where n can be 0, 1, 2, . . . and the predicate is true when the relation exists, otherwise it is false. A proposition in predicate logic may contain quantified variables, which means variables that are introduced by writing “for all x . . . ” or “there exists an x such that . . . ”), and then using the variable x in the proposition that follows.

First-order predicate logic is predicate logic where the quantified variables can be used only as predicate arguments, never as predicates themselves. So

in first-order logic you can express “all cats are black”, but not “all logical relations are true”.

Predicate logic is extremely expressive, but predicate logic sentences are in general very hard to solve. It has been proven that there cannot exist any algorithm that is able to prove every true (tautological) proposition in first-order predicate logic, unless all predicates are restricted to only one argument, i.e. where no multilateral relations are allowed. Since first order predicate logic is idempotent, it can be proven when used for defining state transitions in a process that a certain first state of the process would lead to a certain end state (or a certain number of alternative end states).

In one embodiment of the invention, the rules use a subset of first-order logic that has an efficient proof procedure. This subset is known as Horn Clauses. See further down in the document for more information about Horn clauses and the proof procedure.

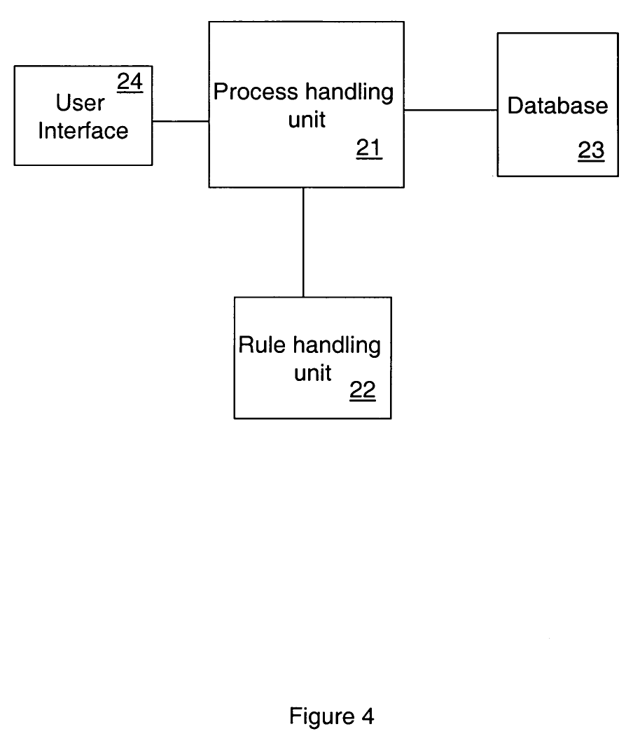

According to one embodiment described in FIG. 4, the arrangement for implementing the method for controlling a process described in this document comprises one or more computers running software for executing the method, and a database server 23 for persistent storage of the process state. The one or more computers have a process handling unit 21 and a rule handling unit 22. The process handling unit 21 is arranged for controlling processes by controlling transitions from an active process state to a new active process state. To achieve this, the process handling unit is adapted to communicate with the database server 23 and the rule handling unit 22. The process handling unit may also be adapted to communicate with a user interface 24. The process handling unit may be e.g. a process engine, a part of a computer program or arrangement for controlling processes, or a separate part or parts of a computer program or computer arrangement that is connectable to a process controlling system.

The rule handling unit 22 is arranged for handling rules, each rule defining a condition for transition between a first process element and at least one other process element when the process changes process state. The rule handling unit is arranged to communicate with the process handling unit 21. In one embodiment, the rule handling unit receives process data from the process handling unit for calculating process elements in the new process state based on its rules. The rule handling unit may be e.g. a rule engine, a part of computer program or arrangement for controlling processes, or a separate part or parts of a computer program or computer arrangement that is connectable to a process controlling system. In some embodiments of the invention, the rule handling unit is embedded in the process handling unit. According to an embodiment of the invention, the rules that the rule handling unit uses are based on first-order predicate logic.

The database server 23 is arranged to store the actual state of the process and other information, and to communicate with the process handling unit. The database server could actually be any kind of storage suitable for storing process states and process data. For less complex processes the storage may be the RAM in the processor of the computer on which the process handling unit is situated, or a computer hard disc etc.

The arrangement for controlling a process may also comprise a user interface 24, such as a graphical user interface (GUI), on which the process may be displayed. The process is advantageously displayed such that boxes indicate the process elements and arrows between the boxes indicate possible transitions. The GUI is also advantageously arranged such that a user can easily detect the current state of the process, i.e. by highlighting the boxes of the current active process elements.

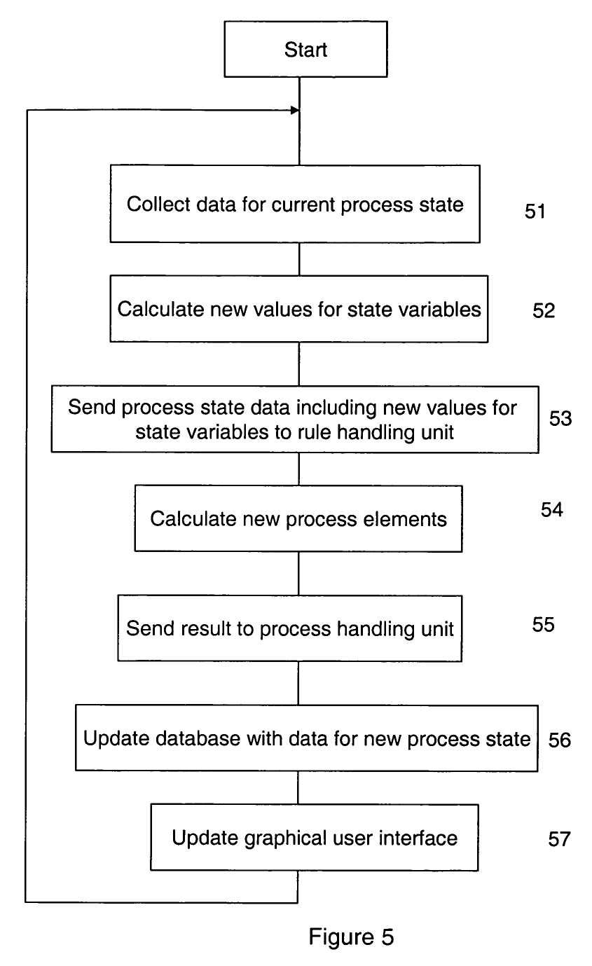

FIG. 5 describes a flow chart according to an exemplary method of the invention for controlling a process. The method starts by the process handling unit collecting 51 data for the initial process state from the database, or from any other storage, e.g. the RAM of the computer on which the process handling unit resides. Such data may be values of process variables, active process elements, and data of the active process elements such as rule data, actions etc. The process handling unit may also receive external input from other units, such as the user interface 24. The process handling unit then calculates 52 new values of process variables based on data of the current active state, such as current values of the process variables and actions of the active process elements, and possibly an external input. Thereafter, process state data including the calculated new values for the state variables are sent 53 to the rule handling unit, which calculates 54 new active process elements based on the rules associated with the current active process elements and the calculated values for the state variables, and possibly an external input. The result, i.e. the new active process elements are sent 55 back to the process handling unit, which updates 56 the database with the data for the new process state, i.e. the new active process elements and the new values of the state variables. If the process is displayed on a graphical user interface, the optional step of updating 57 the graphical user interface with the data for the new process state may also be included.

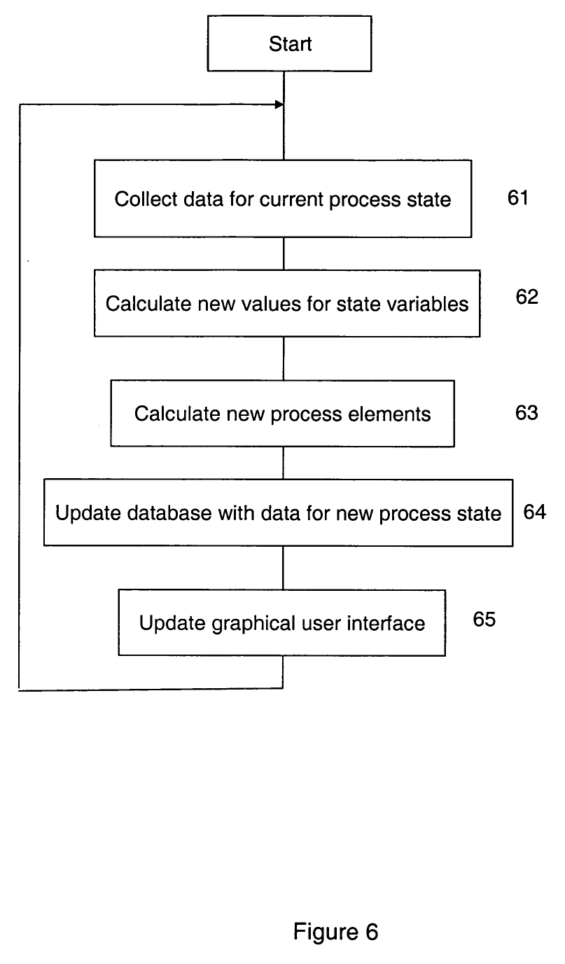

FIG. 6 describes a flow chart of another embodiment of the invention. In this embodiment the calculation steps are performed in one and the same unit, i.e. the rule handling unit and the process handling unit in FIG. 4 are actually only one unit, called a process control unit. In this case, the method starts by the process control unit collecting 61 data for the initial process state from the database, or from any other storage, e.g. the RAM of the computer on which the process control unit resides. Such data may be values of process variables, active process elements, and data of the active process elements such as rule data, actions etc. The process control unit may also receive external input from other units, such as the user interface described in FIG. 4. The process control unit then calculates 62 new values of process variables based on data of the current state, such as current values of the process variables and actions of the active process elements, and possibly an external input. Thereafter, the process control unit calculates 63 new active process elements based on the rules associated with the current active process elements and the calculated new values for the state variables, and possibly an external input. The database is then updated 64 with the data for the new process state, i.e. the new active process elements and the new values of the state variables. If the process is displayed on a graphical user interface, the optional step of updating 65 the graphical user interface with the data for the new process state is also included.

In the method of the second embodiment, the calculation steps are performed such that new values for the state variables and new active process elements are calculated separately for each current active process element according to the following:
calculate new state variable values based on old variable values and actions associated with a first active process element;
calculate new process elements based on the calculated new state variable values and the rule(s) associated with the first active process element;
repeat the calculation steps for each of the other active process elements.

If subprocesses are not independent of each other, e.g. if a state variable value is influenced by actions in two active process elements, it would be necessary to define which action that is to be performed first. For this reason, it is proposed, according to an embodiment of the invention, to check, before the calculation steps, a defined calculation order for the active process elements. As an implementation example, the invention suggests to use semaphores defining that an action cannot be performed unless another action has already been performed. In this case, the step of checking calculation order would be performed by acquiring and releasing semaphores at each process element, and, based on the checking step, decide which process element would be calculated first.

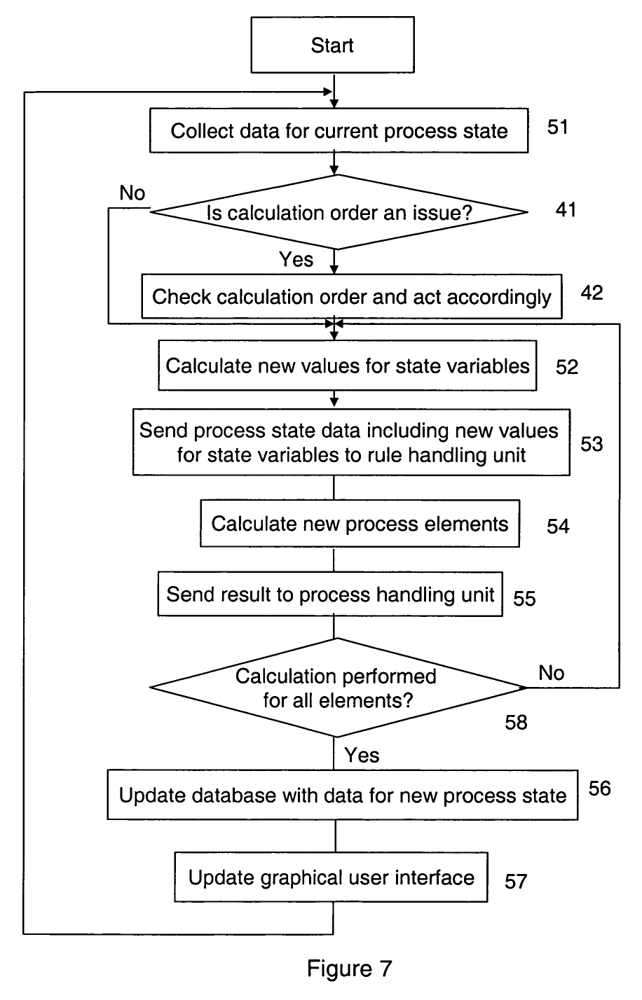

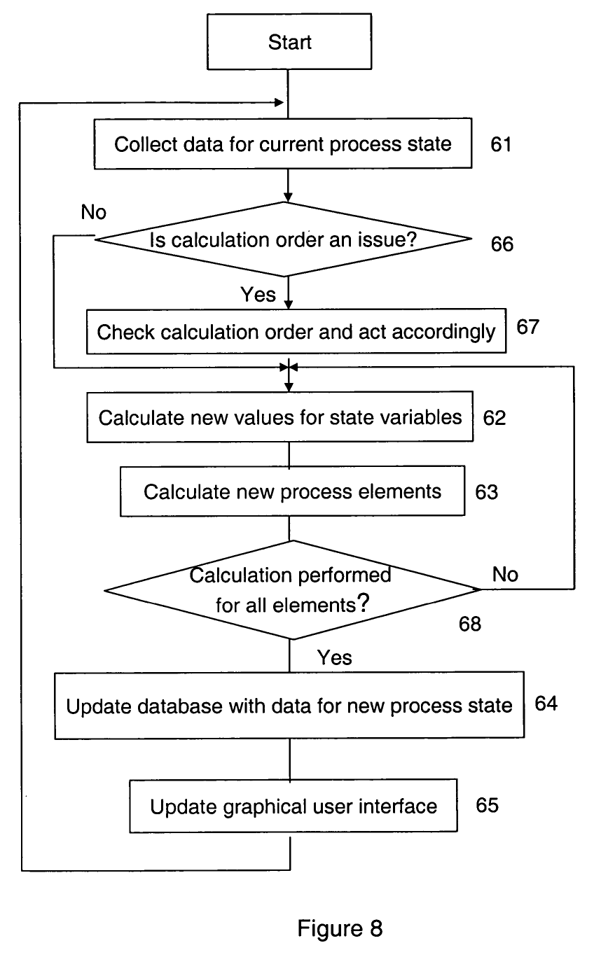

FIGS. 7 and 8 show corresponding flow charts to the flow charts of FIGS. 5 and 6 for the second embodiment of the invention. The differences of FIG. 7 to FIG. 5 are that the calculating steps 52 and 54 are performed on a per active process element basis, such that step of calculating 52 new state variable values is based on old variable values and actions of one of the active process elements, and the step of calculating 54 new process elements is based on the calculated new state variable values and the rule(s) associated with the one of the active process element. The calculation steps 52, 54 and the sending steps 53, 55 will be repeated for all active process elements. For this reason, a new step of checking 58 whether the calculation steps have been performed for all active process elements has been included. Also, a new step of checking 41 whether there would be necessary to take calculation order into consideration is inserted, together with the optional step of checking 42 calculation order for the active process elements, in the case that the calculation order for the active process elements would influence the result.

Similar changes have been made in FIG. 8 compared to FIG. 6. In FIG. 8, a new step of checking 68 whether the calculation steps have been performed per active process element for all active process elements has been included. This step introduces a repetition of the calculation steps 62 and 63, which in FIG. 8 is performed per active process element, until the calculation steps have been performed for all active process elements. Also, a new step of checking 66 whether there would be necessary to take calculation order into consideration is inserted, together with the optional step of checking 67 calculation order for the active process elements, in the case that the calculation order for the active process elements would influence the result.

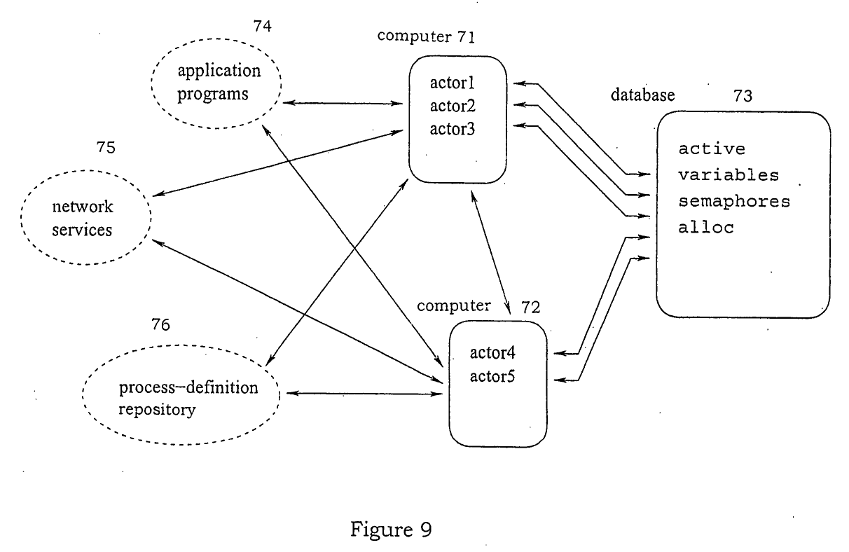

FIG. 9 shows an embodiment of a computer arrangement on which the present invention may be used. The arrangement comprises one or more computers or processors running the software of the invention, in FIG. 9 illustrated by two computers 71, 72, and a database server 73 for persistent storage of the process state. On each of the computers 71 and 72 the software of the process handling unit and the rule handling unit of FIG. 4 are arranged. The control of a process may be divided onto more than one computer for redundancy reasons or if the process control requires lots of computational power. The process handling software creates a variable number of processing execution threads, called actors, for the controlled process, wherein the number of actors equals the number of parallel processing threads. In the example of FIG. 3, there are two parallel processing threads. For control of this process, the process handling software creates two actors. Although, it may be possible to use only one actor that switches between the two parallel processing threads, with the only difference that the process control will be a little bit slower. Such a solution may be useful if e.g. there is, for some reason, a maximum possible number of actors useable in the system.

The database 73 is arranged to store the current active process state, such that data for the active state can be easily communicated with the process handling unit, or other parts of the process control arrangement. It can be arranged for this purpose in any suitable way. The computers 71, 72 have connections to the database 73. The computers may also have connections to external programs and services, such as application programs 74 and network services 75, which may give external input to the control of the process, and to a process-definition repository 76. In the process-definition repository, graph rules are stored, i.e. rules for how graphs are modeled and interpreted. The process-definition repository is used by the definition and development of the process, not when the process is controlled. The process-definition repository may also be situated in the database 73.

The computer arrangement is described as used for an asynchronous process model, as previously described in connection with FIG. 3. As mentioned above, the process handling unit creates a variable number of actors, each actor describing a process execution thread. Each such actor polls a data structure in the database 73 that represents A_{action} as described for the asynchronous process model. Whenever A_{action} is non-empty, the actor removes a process element and executes the action of the process element. Then it applies the rule of the process element to determine which new process elements (if any) to insert in A_{action}. This procedure is repeated for every process state until the process for some reason ends. The use of multiple actors within a single process handling unit allows multiple actions to be executed concurrently. As shown in FIG. 9, it is also possible to utilize multiple process handling units, running on separate computers.

The process model of the invention does not specify what an action is. Any modification of the state variables and any Moore-machine output are examples of actions. The method and arrangement of the invention allows an action to be the execution of any arbitrary computer program, but there are also a small set of “built-in” actions that are useful for updating state variables and managing processes.

Below is described a database according to one embodiment of the invention, e.g. the database of FIG. 9. This database have four database tables, also described in FIG. 9, that are used to represent process state. The first table is named active and represents the multisets A_{action} and A_{cont}. The second table is named variables and represents the process state variables. The third and fourth tables are optional. They are named semaphores and alloc, respectively. They are used for some special cases of state variables. The table active is a type of scheduling queue. Each entry in the queue contains a process element reference. The entry also contains a status field and a semaphore reference. The status field has one of the values new, action, cont, paused, or aborted. A_{action} corresponds to the entries that have the status new or action. Two status codes are used because the actor threads must be able to distinguish between process elements that are awaiting execution, and process elements that have already begun executing their actions but have not yet finished. See further down for a more detailed explanation. A_{cont} corresponds to the entries that have the status cont. The paused status indicates that execution has been stopped due to operator intervention. The aborted status indicates that some unrecoverable error has occurred. Paused and aborted process elements are not included in the abstract process model since their purpose is only to facilitate debugging. The semaphore reference is only used by boxes that wait for semaphores. As mentioned above, semaphores are used to control in which order actions are executed. Together, all entries that have the same (non-null) semaphore field constitute a queue of process elements waiting for that semaphore. Semaphores can always be modeled by a test-and-decrement action in a busy-wait loop, so they do not need any special treatment in the process model. Alloc is a database table keeping track of how many process instances (i.e. parallel processing threads) that has been created by a certain process, such that it is possible to keep process variables belonging to different process instances separated.

Below is shown an exemplary embodiment of how a process handling unit is using the tables in the database, and how the database works. The progression of a process element in and out of the database tables A_{action} and A_{cont} corresponds to three distinct transactions when transiting form a first process state to a second process state. The transactions are performed by the process handling unit in combination with the database. Each actor not used for anything for the moment, looks for a new process element to work with, and a built-in transaction handling unit in the database is used to control that two actors cannot work with the same process element. Although, the transactions are controlled and supervised by the process handling unit. Four transactions are listed below, but the first is actually a special case of the last one:
The process element enters A_{action}, e.g. via a message originating from the process handling unit including data of a new active process state. A reference to the process element is entered into the active table together with the status code new. All idle actor threads are notified that a new process element has entered the active table.
An actor is assigned to the process element. One of the idle actors selects the process element and changes its status code from new to active. This is done as an atomic transaction to prevent two different actors from selecting the same process element for execution.
The actor moves the process element from A_{action} to A_{cont}. The actor executes the process element's action. Any updates to the state variables are committed in this transaction, and the process element entry status is changed from action to cont.
The process element is removed from A_{cont}. In a single transaction, the process element entry is removed from the active table and all of its successor process elements are inserted into the table with status new, depending on if conditions of rules associated with the process element are fulfilled. All idle actor threads are notified that new process elements have entered the active table. The purpose of doing this in a separate transaction is to allow any record locks in the variables table to be released as soon as possible after the action.

A log may also be used that tracks all status changes, for monitoring and auditing purposes.

In this embodiment, crash recovery is easy. For each process element entry with status action, the status is simply reset to new. And for each entry with status cont, the activation rule of that process element is invoked, the process element entry is removed, and its successor process elements are inserted into the table.

Each process element in the active table has a reference to a graph vertex in the process graph, if the process is modeled graphically, together with a context reference that identifies which process instance the process element belongs to. This makes it easy to run multiple instances of the same process definition, where each process instance can have its own independent state and its own private set of state variables. Subprocesses are a special process example. A subprocess is invoked from within another process, using a built-in action. This creates a new context reference. This subprocess context may be nested inside the first context, so that the subprocess instance can access both its own private state variables as wells as state variables in the surrounding context. This is analogous to re-entrant subroutines in conventional computer programming.

A semaphore, which has been described above, is essentially an integer-valued state variable that is used as a synchronization lock. Explicit semaphore programming is considered difficult and prone to deadlocks. Therefore, the embodiments of the invention that use semaphores do not provide Dijkstras classical semaphore operations as primitive actions. Instead, locking and unlocking is done automatically under certain conditions:
Each process element can be controlled by a semaphore. This can be used to guarantee serial access to a process element, or mutual exclusiveness of two or more process elements that share the same semaphore.
Each subprocess can be controlled by a semaphore, in the same way as for a single process element. This allows subprocess invocations to be serialized without having to explicitly declare this in each place it is invoked.

Each message queue has its own private semaphore. This is used to implement waiting for new messages. A message queue consists of a FIFO buffer and an associated semaphore. The FIFO buffer is essentially an array of state variables. When the FIFO is empty, a process element that attempts to read it will block on the semaphore. When data is written to the FIFO, the semaphore is released, causing the blocked process element to proceed. Message queues are especially useful for processes that respond to external events, like for example incoming mail.

As mentioned earlier, multiple process handling units can be configured to share the same database. This is useful for redundancy and load balancing. Since all changes in the process state correspond to database transactions, there can be no interference between different process handling units. However, to avoid unnecessary polling of the active table, the different process handling units are configured to send notifications to each other whenever new process elements are inserted into the table. These notifications are sent using standard network protocols.

The rule handling unit of the invention operates using pure logic, for example first-order predicate logic. According to one embodiment of the invention, the rule handling unit operates on guarded Horn clauses that are resolved using Robinson resolution. Guarded horn clauses are described in “Guarded Horn Clauses” by K. Ueda, published in 1985 as a Technical Report TR-103 by ICOT Research Center, Tokyo, Japan. The design of one implementation of an embodiment of the invention is heavily influenced by some key features in the programming language Andorra Kernel Language (AKL). One of the main benefits of this design is that an answer returned from a rule handling unit is guaranteed to have logical semantics, i.e. it is guaranteed that any answer from any rule handling unit is always logically correct. The rule handling unit uses a simple goal-stacking interpreter that operates on a tree of unresolved guards. Each node in the tree contains a stack of goals that must be satisfied in order to resolve the corresponding guard. A structure-sharing scheme is used for the bindings of logic variables: each time a clause is tried for resolution, a new binding-environment is created for that clause.

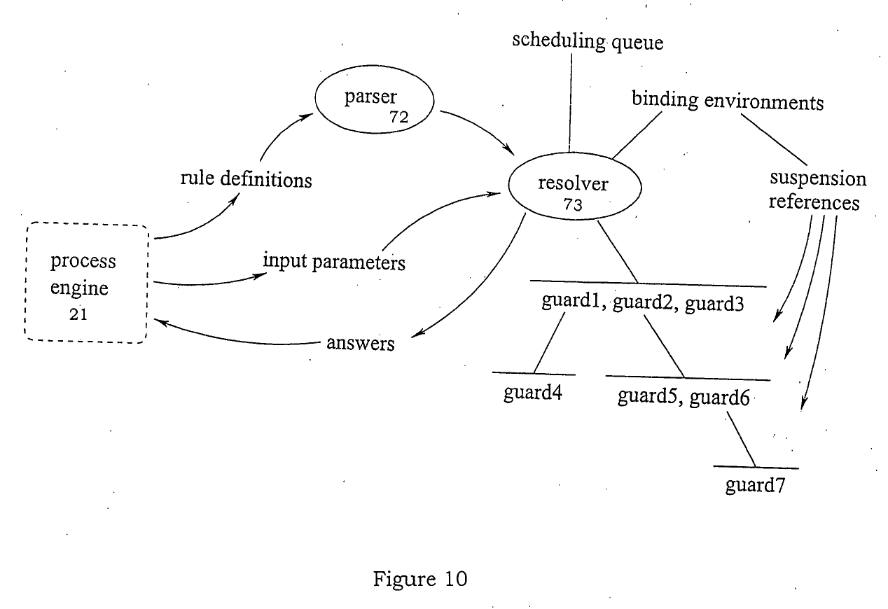

FIG. 10 shows an example of the logical arrangement of a rule handling unit. The rule handling unit communicates with a process handling 21 unit by receiving rule definitions and input parameters regarding the process state, and giving answers to the process handling unit as a result to certain input parameters and the rules of the rule engine. A parser 72 analyses the rule definitions and creates, with the help of a resolver 73, the rules to be used for the process control. The resolver receives input parameters from the process handling unit which input parameters are tried on a rule tree made up from a proof tree containing guards and bodies from predicates defined by guarded Horn clauses, using binding environments and suspensions references for logic variables in order to implement a version of the Robinson resolution principle for proving Horn clauses.

The guard of a guarded Horn clause consists of the clause head together with zero or more predicates that must be resolved before any attempt is made to resolve the rest of the clause. Guards used in this embodiment of the invention are always quiet, and the guard commit is deterministic. Quiet means that no logic variables in the goal may be constrained by unification while resolving the guard. If such a unification fails because it cannot be quiet, the guard resolution is suspended, and the next goal in the current goal-stack (or in the parent goal-stack) is tried instead. Deterministic means that all clauses must have mutually exclusive guards. When a guard has been solved, it is therefore guaranteed that no other clause can resolve the goal.

Scheduling

Goals are generally tried in the order they appear in a clause. But for suspended guards a reference is added to the variable or variables involved in the unification that caused the suspension. Whenever such a variable becomes bound to a value, the corresponding suspended guard (or guards) are added to a scheduling queue. This scheduling queue is polled each time the highest guard in the unresolved tree is suspended. Other scheduling algorithms are also possible.

Process State Parameters

The rules of the rule handling unit may contain parameters that are defined outside the rule set. Logically, such a parameter is just a free variable, i.e. it is quantified outside the entire set of Horn clauses. The rule handling unit uses such parameters to access state variables within predicate definitions. This access is guaranteed to be idempotent: two occurrences of the same parameter will always have the same value during the application of a rule, even if other processes are concurrently updating the corresponding state variable.

Non-Deterministic Parameters

Non-deterministic parameters are similar to the process state parameters, but they are not constrained to a single value. The rule handling unit handles such parameters by first trying to resolve as much as possible using deterministic methods (e.g. using “The Andorra Principle”) and when that results in suspension, the tree of unresolved guards is cloned into multiple versions, where each version has a separate value for the non-deterministic parameter.

In this document, a process is described as a number of process variables and as process elements, which each include rules for transitions to other process elements and actions to be performed when the process element is active. An active process state is described as a number of process elements including their actions, and as current values of the process variables. By making transition calculations to a new process state in two separate steps by first calculating new process variable values based on current process values and actions in the current active process elements and then calculating new active process elements based on the new process variables and rules in the current active process elements for transitions to new process elements, a process control system and method is received that is flexible enough to handle most different kinds of processes and that can be realised with a limited amount of program code.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A method in a computer system for controlling a process, which process is modeled as a set of process elements (bᵢ and a number of process state variables (vᵢ, each process element being associated with at least one action and at least one rule (rᵢ) defining a condition for transition from the process element to other process elements, wherein a process state is represented by a number of process elements and by values of the number of state variables, wherein the method controls transition from a first process state to a second process state by:
calculating values in the second process state for the number of state variables as a function of values in the first process state for the number of state variables and of actions associated with the number of process elements in the first process state, and
calculating process elements for the second process state as a function of the rules associated with the number of process elements in the first process state and of the calculated values in the second process state for the number of state variables.

2. Method according to claim 1, wherein the steps of calculating are performed separately for each process element in the first process state, and wherein the method further comprises the step of repeating the calculation steps for each process element in the first process state.

3. Method according to claim 2, further comprising the step of checking a defined calculation order for each process element in the first process state before calculating the values in the second process state.

4. Method according to any of claims 1-3, wherein the rules are specified using first-order predicate logic.

5. Method according to claim 4, wherein the first-order predicate logic is based on Horn clauses that has an efficient proof procedure.

6. Method according to any of claims 1-5, further comprising the step of storing the calculated values in the second process state and the calculated process elements in the second process state by updating a database keeping an updated version of a current active process state.

7. Method in a computer system for controlling a process, which process is modeled as a set of process elements (bᵢ) and a number of process state variables (vᵢ), each process element being associated with at least one action and at least one rule (rᵢ) defining a condition for transition from the process element to other process elements, wherein a process state is represented by a number of process elements and by values of the number of state variables, wherein the method controls transition from a first process state to a second process state by:
collecting values in the first process state for the number of state variables and data regarding actions and rules for process elements in the first process state from a database storing data related to the process;
calculating values in the second process state for the number of state variables as a function of values in the first process state for the number of state variables and of actions associated with the number of process elements in the first process state;
calculating process elements for the second process state as a function of the rules associated with the number of process elements in the first process state and of the calculated values in the second process state for the number of state variables; and
updating the database with values in the second process state for the number of state variables and the process elements in the second process state.

8. Method according to claim 7, wherein the calculating steps are performed separately for each process element in the first process state, and wherein the method further comprises the step of repeating the calculating steps for the number of process elements in the first process state.

9. Method according to claim 8, further comprising the step of checking a defined calculation order for each process element in the first process state before calculating the values in the second process state.

10. Method according to any of claims 7-9, wherein the rules are specified using first-order predicate logic based on Horn clauses.

11. Arrangement in a computer system for controlling a process, which process is modeled as a set of process elements (bᵢ) and a number of process state variables (vᵢ), each process element being associated with at least one action and at least one rule (rᵢ), defining a condition for transition from the process element to other process elements, wherein a process state is represented by a number of process elements and by values of the number of state variables,
the arrangement comprising:
a rule handling unit comprising a number of rules, each rule being associated with a process element;
a process handling unit arranged for communicating with the rule handling unit and for controlling the process by controlling transitions from a first process state to a second process state, the arrangement being arranged for:
calculating values in the second process state for the number of state variables as a function of values in the first process state for the number of state variables and of actions associated with the number of process elements in the first process state, and
calculating process elements for the second process state as a function of the rules associated with the number of process elements in the first process state and of the calculated values in the second process state for the number of state variables.

12. Arrangement in a computer system according to claim 11, wherein the rule handling unit is arranged to specify the rules using first-order predicate logic.

13. Arrangement in a computer system according to claim 11 or 12, the arrangement further comprising a database for storing data related to the process and a current active process state, wherein the process handling unit is further adapted to:
receive, from the database, values in the first process state for the number of state variables and data for actions and rules for process elements in the first process state, and
send, to the database, values in the second process state for the number of state variables and the process elements in the second process state.

14. Arrangement in a computer system according to claim 13, further comprising
a user interface arranged for presenting the current active process state to a user, wherein the user interface is arranged to receive the current active process state from the database, via the process handling unit.

15. Arrangement according to claim 14, wherein the user interface is further arranged for receiving external input influencing the control of the process, and wherein the process handling unit is arranged to receive the external input and to take the external input into consideration when calculating the values of the state variables in the second process state and when calculating the process elements in the second process state.
